(19) United States
(12) Patent Application Publication
(10) Pub. No.: US 2026/0368231 A1
(43) Pub. Date: Nov. 19, 2026

(54) HYPERGRAPH-BASED CACHING OF LANGUAGE MODEL QUERIES

(71) Applicant: Dell Products L.P., Round Rock, TX (US)

(72) Inventors: Pankaj Pande, Carlingford (AU); Gaurav Chawla, Austin, TX (US)

(21) Appl. No.: 19/211,493

(22) Filed: May 19, 2025

(51) Int. Cl. G06F 16/3349; G06F 16/334; G06F 16/901

(52) U.S. Cl. CPC G06F 16/3349; G06F 16/3344; G06F 16/9024

(57) ABSTRACT

Techniques are provided for hypergraph-based caching of language model queries. A method includes obtaining a query; determining, using a hypergraph having nodes that represent previous queries stored in a cache, whether the query matches a given one of the previous queries based on one or more designated matching criteria, by evaluating a semantic similarity and/or a contextual similarity of the previous queries to the query, wherein the hypergraph includes at least one hyperedge that connects at least three nodes in the hypergraph; and generating, based on a result of the evaluating, a query response to the query by processing a query response associated with the given previous query. The hypergraph may include a multi-layer hypergraph having at least a first layer that includes nodes associated with different information categories and at least a second layer that includes nodes associated with different queries.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Some artificial intelligence techniques are trained to answer various user queries (e.g., questions). As workloads for such artificial intelligence-based query-response techniques grow in complexity, repeated queries, often with subtle semantic variations, may cause system inefficiencies, increased latency and/or increased token costs.

### SUMMARY

Illustrative embodiments of the disclosure provide techniques for hypergraph-based caching of language model queries. One method includes obtaining at least one query; determining, using at least one hypergraph comprising a plurality of nodes that represent respective ones of a plurality of previous queries stored in at least one cache, whether the at least one query matches at least a given one of the previous queries based at least in part on one or more designated matching criteria, by evaluating one or more of a semantic similarity and a contextual similarity of the one or more previous queries to the at least one query, wherein the at least one hypergraph comprises at least one hyperedge that connects at least three nodes in the at least one hypergraph; and generating, based at least in part on a result of the evaluating, at least one query response to the at least one query by processing a query response associated with the given previous query.

Illustrative embodiments can provide significant advantages relative to conventional techniques. For example, technical problems related to such conventional techniques are mitigated in one or more embodiments by using at least one hypergraph to represent previous queries and query responses stored in a cache.

These and other illustrative embodiments described herein include, without limitation, methods, apparatus, systems, and computer program products comprising processor-readable storage media.

### BRIEF DESCRIPTION OF THE DRAWINGS

FIG. 1 illustrates an information processing system configured for hypergraph-based caching of language model queries in accordance with an illustrative embodiment;

FIG. 2A illustrates a representative hypergraph in accordance with an illustrative embodiment;

FIG. 2B illustrates a hypergraph incidence matrix for the representative hypergraph of FIG. 2A in accordance with an illustrative embodiment;

FIG. 3 is a flow diagram illustrating an exemplary implementation of a process for hypergraph-based caching of language model queries in accordance with an illustrative embodiment;

FIG. 4 is a process diagram illustrating an exemplary implementation of a process for hypergraph-based adaptive caching in accordance with an illustrative embodiment;

FIG. 5 is a process diagram illustrating an exemplary implementation of a hypergraph update process in accordance with an illustrative embodiment;

FIG. 6 is a process diagram illustrating an exemplary implementation of a forecast score computation process in accordance with an illustrative embodiment;

FIG. 7 is a process diagram illustrating an exemplary implementation of a reinforcement learning (RL) state formulation process in accordance with an illustrative embodiment;

FIG. 8 is a process diagram illustrating an exemplary implementation of an RL-based cache action selection process in accordance with an illustrative embodiment;

FIG. 9 is a process diagram illustrating an exemplary implementation of a selected cache action execution process in accordance with an illustrative embodiment;

FIG. 10 is a process diagram illustrating an exemplary implementation of a reward computation and RL policy training process in accordance with an illustrative embodiment;

FIG. 11 is a flow diagram illustrating an exemplary implementation of a process for hypergraph-based caching of language model queries in accordance with an illustrative embodiment;

FIG. 12 illustrates an exemplary processing platform that may be used to implement at least a portion of one or more embodiments of the disclosure comprising a cloud infrastructure; and

FIG. 13 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for hypergraph-based caching of language model queries.

One or more aspects of the disclosure recognize that existing caching techniques may fail to capture certain relationships among queries, leading to missed caching opportunities, increased costs and/or inadequate resource utilization. As the number of queries being processed increases, inefficiencies may arise, leading to increased operational costs and/or latency (especially in scenarios where queries exhibit complex relationships that traditional linear or hierarchical caches may not capture). Queries may differ by domain, complexity, user behavior and/or semantics. Thus, storing such queries in a simple key-value or graph-based cache structure may lose valuable contextual relationships that are important for efficient caching decisions.

In one or more embodiments, the disclosed hypergraph-based caching techniques employ multi-node hypergraphs, to represent queries and associated responses, enriched with semantic, contextual and/or behavioral links. Hierarchical hypergraphs may be employed to model multi-level relationships among queries and responses, to further improve cache performance in complex environments.

Hypergraph neural networks (HGNNs) are provided for modelling multi-dimensional (e.g., high-dimensional) relationships between queries capturing, for example, semantic overlap and usage patterns in a unified structure. The disclosed HGNN framework uses a hypergraph structure for query modelling where a hypergraph can encode multi-dimensional relationships between queries and hyperedges represent relationships between nodes, such as semantic similarity, contextual relevance and/or usage patterns. While traditional edges typically make pairwise node connections, a hyperedge can join any number of nodes.

Dynamic RL models are employed in at least some embodiments to make real-time decisions on caching, eviction and/or promotion/demotion of cache entries. Predictive query complexity scoring techniques may be employed to identify whether a query is likely to benefit from caching based on historical usage, estimated compute cost and/or a similarity to existing nodes in the hypergraph. Edge computing techniques may be employed in some embodiments for geographically distributed updates of the hypergraphs (e.g., thereby reducing central server load and/or latency).

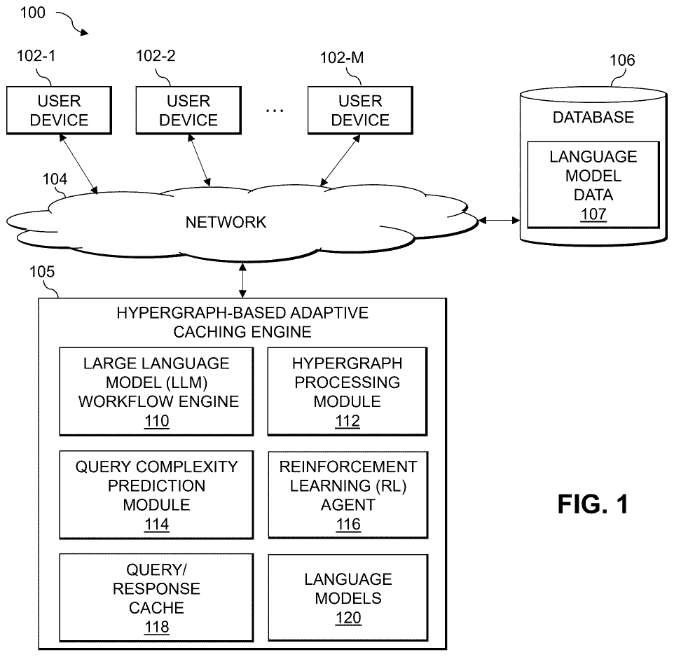

FIG. 1 shows an information processing system 100 configured in accordance with an illustrative embodiment. The information processing system 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger information processing system 100. Also coupled to network 104 is a hypergraph-based adaptive caching engine 105 and a database system 106.

The user devices 102 may comprise, for example, devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the information processing system 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the information processing system 100, including a wide area network (WAN), a local area network (LAN), a satellite network, a telephone or cable network, a cellular network, a wireless network such as a Wi-Fi or WiMAX network, or various portions or combinations of these and other types of networks. The information processing system 100 in some embodiments therefore comprises combinations of multiple different types of networks, each comprising processing devices configured to communicate using internet protocol (IP) or other related communication protocols.

The hypergraph-based adaptive caching engine 105 may comprise a large language model (LLM) workflow engine 110, a hypergraph processing module 112, a query complexity prediction module 114, an RL agent 116, a query/response cache 118 and one or more language models 120. The query/response cache 118 may selectively cache previous queries and/or query responses.

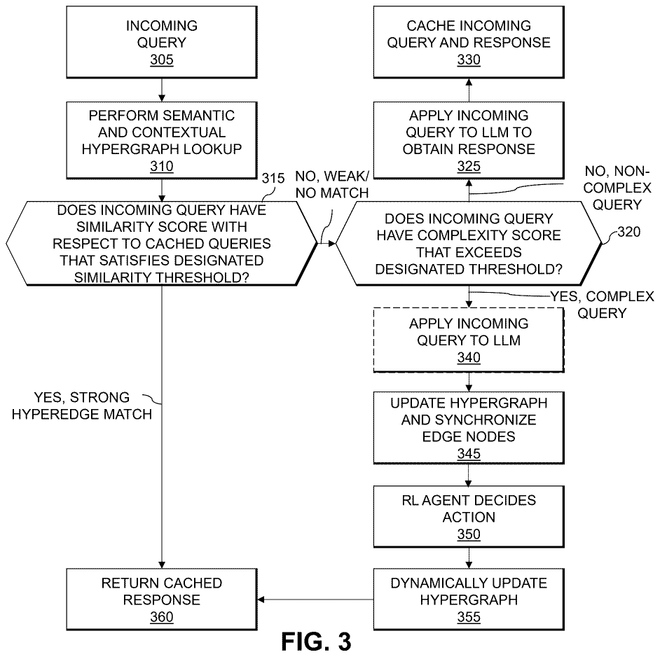

In one or more embodiments, new queries may be passed through the LLM workflow engine 110, which can generate a common word embedding vector in some embodiments for each query and perform other tasks for processing queries. A word embedding vector may be generated, for example, using an embedding method such as term frequency-inverse document frequency (TF-IDF), latent semantic analysis (LSA), GloVe, Word2Vec, etc. The LLM workflow engine 110 may employ the hypergraph processing module 112 to evaluate the similarity of a new query with respect to previously processed queries, in relation to the new/input query, using at least one hypergraph, as discussed further below in conjunction with FIG. 3, for example.

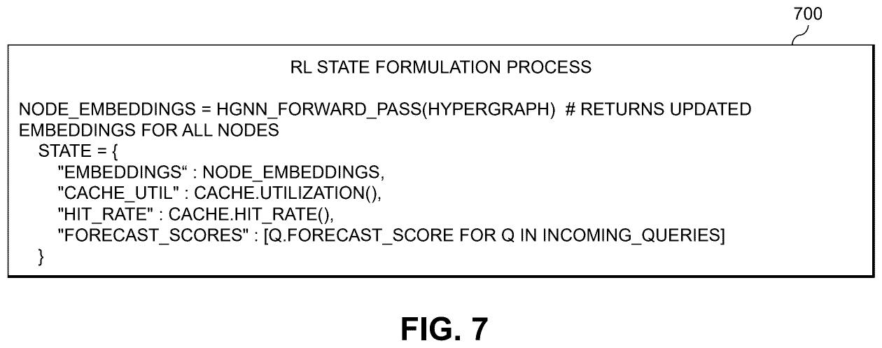

The query complexity prediction module 114, in some embodiments, calculates a query complexity score for one or more new queries, as discussed further below in conjunction with FIG. 3, to identify complex queries for special processing. In this manner, the query complexity scores may be employed to identify whether a query is likely to benefit from caching based on historical usage, estimated compute cost and/or a similarity to existing nodes in the hypergraph. The RL agent 116 may update one or more caching strategies to adapt to new usage modes (e.g., post-launch query surges and/or seasonal query spikes) and to update the hypergraphs, as discussed further below in conjunction with FIGS. 7 through 10.

The one or more language models 120 may comprise, for example, LLMs or other models that can generate text and perform natural language processing (NLP) tasks, that determine a response to a user of a respective user device 102, as discussed herein. The language models 120 may learn statistical relationships from a training dataset comprised of text documents using a self-supervised training process and/or a semi-supervised training process, for example.

The term “language model” as used herein is intended to be broadly construed so as to encompass, for example, natural language processing models trained on textual data to understand, generate, predict and/or summarize new content. The language models 120 may be implemented, for example, using transformer-based architectures that process input through a sequence of transformers, where each transformer includes a self-attention layer and a feedforward layer. Generally, the self-attention layer computes an importance of each token in a sequence of input tokens, and the feedforward layer transforms the output of the self-attention layer into a form that is suitable for the next transformer in the sequence.

It is to be appreciated that this particular arrangement of elements 110, 112, 114, 116, 118 and/or 120 illustrated in the hypergraph-based adaptive caching engine 105 of the FIG. 1 embodiment is presented by way of example only, and alternative arrangements can be used in other embodiments. For example, the functionality associated with the elements 110, 112, 114, 116, 118 and/or 120 in other embodiments can be combined into a single module, or separated across a larger number of modules. As another example, multiple distinct processors can be used to implement different ones of the elements 110, 112, 114, 116, 118 and/or 120 or portions thereof.

At least portions of elements 110, 112, 114, 116, 118 and/or 120 may be implemented at least in part in the form of software that is stored in memory and executed by a processor.

Additionally, the database system 106 may comprise one or more databases, such as language model data 107 comprising data pertaining to, for example, historical queries, input queries, query embeddings, query token count data, query similarity score data, etc. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The language model data 107 may be configured to store data, for example, in tables, in a known manner. While the database system 106 is illustrated in FIG. 1 as a single database, at least portions of the database system 106 may be implemented as multiple distinct databases. Example database system 106, such as depicted in the present embodiment, can be implemented using one or more storage systems associated with the hypergraph-based adaptive caching engine 105. Such storage systems can comprise any of a variety of different types of storage including network-attached storage (NAS), storage area networks (SANS), direct-attached storage (DAS) and distributed DAS, as well as combinations of these and other storage types, including software-defined storage.

At least one embodiment includes obtaining and/or intercepting a user prompt and/or query (after submission via at least one of user devices 102, for example) and verifying if the prompt and/or query has already been submitted using the hypergraph-based adaptive caching engine 105, as discussed herein. If the prompt and/or query is determined to be sufficiently different from the previously submitted historical prompts and/or queries, one or more embodiments can include processing the prompt and/or query to determine a query response.

Also associated with the hypergraph-based adaptive caching engine 105 are one or more input-output devices, which illustratively comprise keyboards, displays or other types of input-output devices in any combination. Such input-output devices can be used, for example, to support one or more user interfaces to the hypergraph-based adaptive caching engine 105, as well as to support communication between hypergraph-based adaptive caching engine 105 and other related systems and devices not explicitly shown.

Additionally, the hypergraph-based adaptive caching engine 105 in the FIG. 1 embodiment is assumed to be implemented using at least one processing device. Each such processing device generally comprises at least one processor and an associated memory, and implements one or more functional modules for controlling certain features of the hypergraph-based adaptive caching engine 105.

More particularly, the hypergraph-based adaptive caching engine 105 in this embodiment can comprise a processor coupled to a memory and a network interface.

The processor illustratively comprises a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage drive, a storage array or an integrated circuit containing memory, as well as a wide variety of other types of computer program products. The term “article of manufacture” as used herein should be understood to exclude transitory, propagating signals. These and other references to “drives” herein are intended to refer generally to storage devices, including solid-state drives (SSDs), and should therefore not be viewed as limited in any way to particular storage media types.

The network interface allows the hypergraph-based adaptive caching engine 105 to communicate over the network 104 with the user devices 102, and illustratively comprises one or more conventional transceivers.

It is to be understood that the particular set of elements shown in FIG. 1 for the hypergraph-based adaptive caching engine 105 involving user devices 102 of information processing system 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the hypergraph-based adaptive caching engine 105 and at least portions of the database system 106 can be on and/or part of the same processing platform.

In one or more embodiments, the hypergraph-based adaptive caching engine 105 may be configured to cache a query (e.g., a request or prompt), and a corresponding query response (e.g., generated by a given language model). If a query response to a given new query is found in the query/response cache 118, the query response can be retrieved from the query/response cache 118 and returned, thus eliminating the need to process the query using a language model, which can improve the performance and reduce the cost of the language models.

In one or more embodiments, data to be cached in the query/response cache 118 can include, e.g., a hash created of the embedding vector of the query, search domain identifying information (e.g., user, role, program and/or chatbot identifier (ID)), the vector of the query as generated from vectorization, the token size of the query, and the response from the language model.

In some embodiments, if a search of the query/response cache 118 does not turn up a match (e.g., indicating that an exact match is not stored in the query/response cache 118), the hypergraph-based adaptive caching engine 105 can return previous responses associated with one or more similar previously asked queries from the query/response cache 118. Similarity search algorithms such as, e.g., cosine similarity or Euclidian distance, can be applied in some embodiments on cache data along with the current query being asked to evaluate similarity scores.

By way merely of example, in connection with text analysis, one or more embodiments can include using cosine similarity to compare the orientation of two text documents as vectors in a multi-dimensional space. By calculating the cosine of the angle between these two vectors, such an embodiment can include deriving a similarity score (e.g., a score ranging from −1 to 1, wherein 1 indicates that the vectors are perfectly aligned (indicating identical direction and maximum similarity), 0 indicates orthogonality (i.e., no similarity), and −1 represents completely opposite directions). In such an embodiment, a score closer to 1 indicates a high degree of similarity and a score closer to 0 indicates dissimilarity.

Any query to a language model can be broken up into tokens during encoding, and relevant token count rules may be applied to each language model. By way merely of example, tokens can represent words and/or other characters (such as commas) in the query. Also, language models can often support different token count limits.

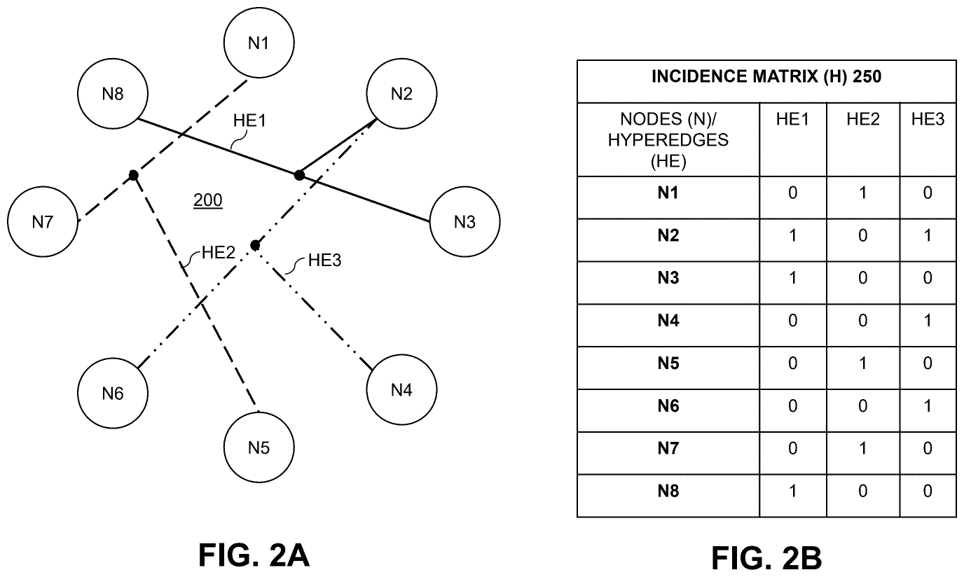

FIG. 2A illustrates a representative hypergraph 200 in accordance with an illustrative embodiment. One or more aspects of the disclosure recognize that a single hyperedge can link any number of nodes, capturing semantic equivalences and/or contextual overlap in ways that a standard graph cannot.

In the example of FIG. 2A, a hypergraph 200 comprises a plurality of nodes N1 through N8, interconnected by hyperedges HE1 through HE3 (each identified in FIG. 2A using a different dash pattern). Let H=(V, E) denote a hypergraph, where V is the set of nodes, each node vᵢ∈V represents a unique query or a cached response and E⊆2^{V} is the set of hyperedges. Each hyperedge eⱼ connects a subset of nodes {vⱼ₁, vⱼ₂, . . . , vⱼₖ}. An HGNN may process H to learn node embeddings, Z∈ [symbol] . The hypergraph 200 may be updated, as follows:

$${Z}^{( l + 1 )} = σ ( {D}_{v}^{\{ - 1 / 2 \}} H {W}_{e} {H}^{T} {D}_{v}^{\{ - 1 / 2 \}} {Z}^{( l )} {W}_{l} ) ,$$

where Z^{(l)} is the embedding at layer l; Wₑ and Wₗ are learnable weight matrices; Dᵥ is the diagonal degree matrix of the nodes and σ(⋅) is a non-linear activation function (e.g., a rectified linear unit (ReLU) activation function).

In some embodiments, a multi-layered hypergraph may be employed. For example, nodes in a top-level (e.g., a macro level) of the multi-layered hypergraph may be used to represent broad categories of information (e.g., queries associated with “laptops” or a “data center”); a middle-level (e.g., a contextual level) of the multi-layered hypergraph may be used to represent context information (e.g., queries associated with “firmware updates” for laptops); and a fine-grained-level (e.g., an instance level) of the multi-layered hypergraph may be used to represent specific queries.

As noted above, edge computing techniques may be employed for geographically distributed updates of the hypergraphs (e.g., reducing central server load and/or latency). For example, local hypergraph updates may comprise regional edge nodes maintaining local hypergraph segments (e.g., actively updating hypergraph connections based on regional query traffic) and local queries in the local partial hypergraph segments being merged into a global hypergraph by a global orchestrator to maintain coherence, as needed. This distributed approach ensures reduced (e.g., minimal) latency for geographically diverse queries. In addition, edge nodes may also train, at least in part, one or more of the RL models described herein, and gradients and/or policy parameters may be sent to the central orchestrator. In this manner, the network load is reduced and privacy-preserving learning is enabled.

FIG. 2B illustrates a hypergraph incidence matrix 250 for the representative hypergraph of FIG. 2A in accordance with an illustrative embodiment. In the example of FIG. 2B, the hypergraph incidence matrix 250 describes which nodes (e.g., queries or responses) are associated with which hyperedges, capturing multi-node relationships. The hypergraph incidence matrix 250, H∈{0,1}^{{|V|×|E|}}, may be constructed, as follows:

```
H(i, j) = {
  1 if vᵢ ∈ eⱼ,
  0 otherwise
}
```

FIG. 3 is a flow diagram illustrating an exemplary implementation of a process for hypergraph-based caching of language model queries in accordance with an illustrative embodiment. In the example of FIG. 3, a semantic and context lookup is performed on an incoming query 305 in step 310 (e.g., using an understanding of a meaning of words and phrases, and the context in which such words and phrases are used).

A test is performed in step 315 to determine if the incoming query 305 has a similarity score with respect to one or more cached queries that satisfies at least one designated similarity threshold. The test performed in step 315 may, in some embodiments, comprise a hypergraph-based similarity check, where the incoming query 305 is embedded and compared against cached queries using both semantic and contextual features. A match is found if a cosine similarity between the embedding of the incoming query 305 and the embedding of one or more cached queries exceeds a predefined threshold (e.g., 0.8), and if the queries fall within the same contextual cluster (e.g., product type and/or task intent). If a match is identified, a response to the incoming query 305 can be served directly from the query/response cache.

If it is determined in step 315 that the incoming query 305 has a similarity score with respect to one or more cached queries that satisfies the designated similarity threshold, then the cached response associated with the similar previous query may be returned in step 360.

If, however, it is determined in step 315 that the incoming query 305 does not have a similarity score with respect to one or more cached queries that satisfies the designated similarity threshold, then a further test is performed in step 320 to determine if the incoming query 305 has a complexity score that exceeds a designated complexity threshold. In some embodiments, the complexity score for a given query may be calculated, as follows:

Complexity(Q)=λ¹·TokenCost(Q)+λ²·(1−CacheHitLikelihood(Q)+λ³·SemanticDelta(Q)

where TokenCost(Q) provides an estimated LLM inference cost for the given query (e.g., token length and/or compute time); CacheHitLikelihood(Q) indicates an expected hit rate for the given query (and (1−CacheHitLikelihood(Q)) models a miss potential); SemanticDelta(q) indicates a semantic divergence of the given query from existing cache entries; and λ¹, λ², and λ³ comprise weights that allow the hypergraph-based adaptive caching engine 105 to tune emphasis across these dimensions.

If it is determined in step 320 that the incoming query 305 does not have a complexity score that exceeds the designated complexity threshold, then the incoming query 305 (e.g., a non-complex query) is applied to an LLM in step 325 to obtain a response. The incoming query 305 and the response generated by the LLM are cached in step 330 (e.g., without updating the hypergraph).

If it is determined in step 320 that the incoming query 305 has a complexity score that exceeds the designated complexity threshold, then the incoming query 305 (e.g., a complex query) may be applied to an LLM in step 340 in some embodiments (as shown with a dashed outline) to obtain a response. In step 345, the hypergraph is updated (e.g., by the central orchestrator) with the incoming query 305 and the response generated by the LLM, and the edge nodes are synchronized. The system may update the hypergraph in near real-time in some embodiments. Step 345 refers to a structural update, where the hypergraph is extended with a new node (e.g., associated with tan incoming query) and associated edges are created based on a semantic similarity and query context. The hypergraph update of step 345 may also involve syncing the hypergraph with edge nodes.

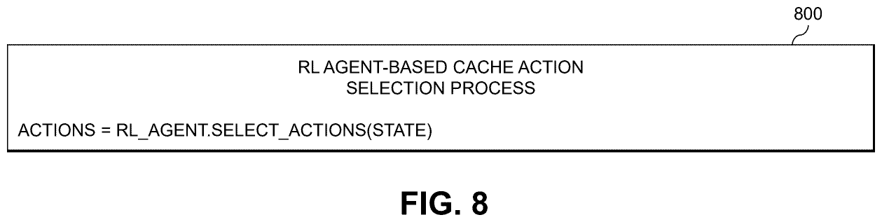

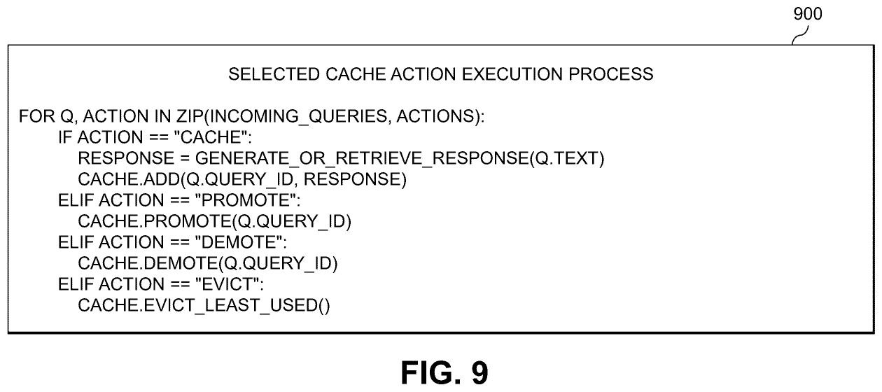

In some embodiments, step 340 may be performed in a baseline configuration, in response to the determination that an incoming query fails to meet the similarity threshold (step 315) and the determination that the incoming query is a complex query (step 320). In an adaptive mode, on the other hand, the RL agent 116, in connection with step 350, discussed below, can determine whether the LLM call should proceed immediately, be deferred or be optimized in the context of resource constraints, recent cache dynamics and/or predicted reuse potential. For example, if the forecast score for the incoming query is high, the RL agent 116 may choose an action to call the LLM and cache the result immediately, as discussed further below in conjunction with FIGS. 8 and 9, for example. If the forecast score for the incoming query is low, or the determined reuse uncertainty is high, the RL agent 116 may skip the LLM call, defer the LLM call or label the LLM call as low-priority.

The RL agent 116 decides the next action in step 350, as discussed further below in conjunction with FIG. 8. The hypergraph is dynamically updated in step 355 (e.g., with the incoming query 305 and the response generated by the LLM, if any), and the generated response is returned to the user in step 360. The hypergraph update of step 355 reflects a strategic update, where the RL agent 116 chose to alter existing relationships (e.g., promoting or demoting hyperedges, reweighting edge importance or pruning obsolete nodes). For example, while the update of step 345 may be performed to integrate new query data, the update of step 355 may optimize the hypergraph, for example, based on learned policy decisions.

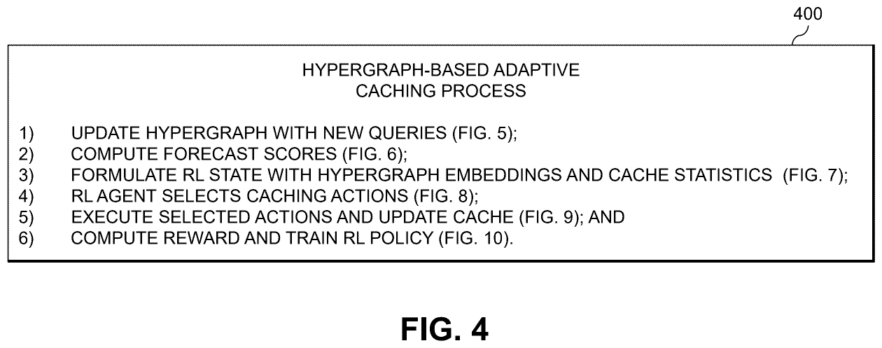

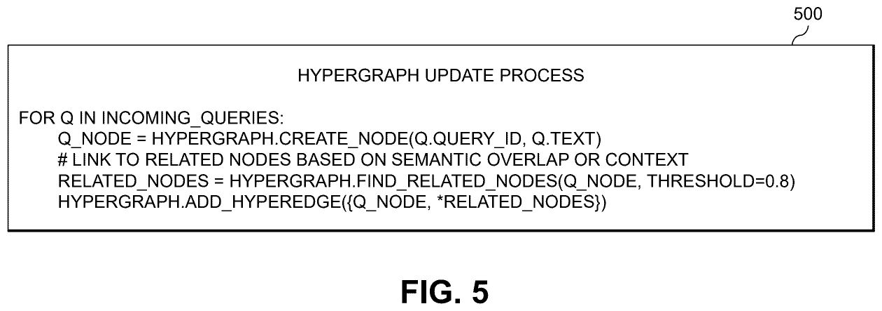

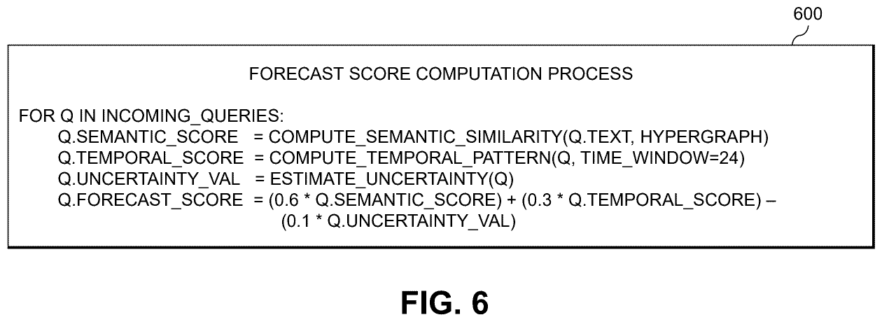

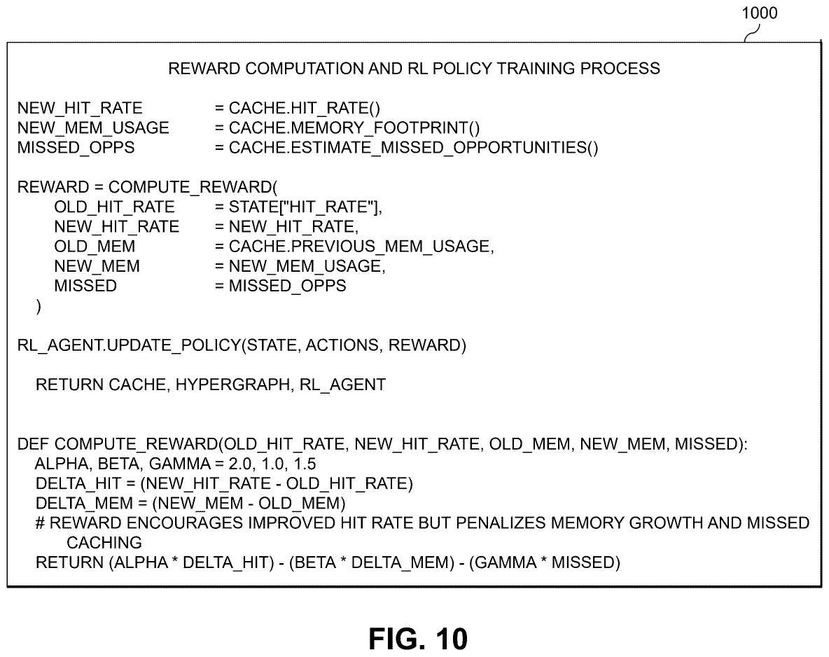

FIG. 4 is a process diagram illustrating an exemplary implementation of a process 400 for hypergraph-based adaptive caching in accordance with an illustrative embodiment. In the example of FIG. 4, the hypergraph-based adaptive caching process 400 initially updates the hypergraph with one or more new queries, as discussed further below in conjunction with FIG. 5, and then computes forecast scores for the one or more new queries, as discussed further below in conjunction with FIG. 6. The RL state may be formulated with hypergraph embeddings and cache statistics, for example, using the techniques of FIG. 7, and the RL agent selects one or more caching actions using the techniques of FIG. 8. The hypergraph-based adaptive caching process 400 may execute the selected actions and update the cache (e.g., query/response cache 118), as discussed further below in conjunction with FIG. 9. Finally, the hypergraph-based adaptive caching process 400 computes a reward and trains the RL policy, as discussed further below in conjunction with FIG. 10.

FIG. 5 is a process diagram illustrating an exemplary implementation of a hypergraph update process 500 in accordance with an illustrative embodiment. In the example of FIG. 5, for each Q in incoming_queries, the hypergraph update process 500 creates a node in the hypergraph and identifies related nodes (e.g., based on semantic overlap and/or context) and creates hyperedges (e.g., links) each new query and the identified related nodes for the new query.

FIG. 6 is a process diagram illustrating an exemplary implementation of a forecast score computation process 600 in accordance with an illustrative embodiment. The forecast scores represent a likelihood of being reused (e.g., by a repeated query), which may be used to determine whether to predictively cache a given new query in the query/response cache 118. In the example of FIG. 6, the forecast score computation process 600 computes a forecast score (e.g., a part of the RL state) incorporating semantic similarity, temporal frequency and/or uncertainty. Assume that each query is embedded as q_{embed}∈ [symbol] , using a transformer encoder, and that rᵢ is the embedding of cached response vᵢ.

The semantic similarity component of the forecast score may be computed, as follows:

$$Sim ( {Q}_{embed , {r}_{i}} ) = \frac{( {Q}_{embed \cdot {r}_{i}} )}{( ‖ {Q}_{embed} ‖ \cdot ‖ {r}_{i} ‖ )} ,$$

where the double vertical lines in the denominator indicate an L2 norm of a vector (e.g., a Euclidean norm (magnitude) of the embedding vector, as used in the following cosine similarity formula). A cosine similarity evaluation, for example, may be expressed, as follows:

$$S ( Q , {Q}^{′} ) = \frac{e ( Q ) e ( {Q}^{′} )}{‖ e ( Q ) ‖ ‖ e ( {Q}^{′} ) ‖} ,$$

where a similarity threshold θₜ for the similarity evaluation may be adapted by the RL agent 116. The embeddings may be expressed as E∈ [symbol] . If the incoming query is found in the cache, the cached response is returned to the user.

The temporal patterns component may be computed by defining a temporal function T(q, t) representing query frequency over a sliding time window (e.g., 24 hours or 7 days), normalized by average volume.

The uncertainty estimation component (e.g., reuse uncertainty) may be computed by using a Bayesian dropout or ensemble methods to compute the uncertainty, as follows:

U(Q)∈[0,1],

where a higher U(Q) value indicates a greater uncertainty (e.g., less confidence in reuse).

Thus, the forecast score for a given query may be computed, as follows:

ForecastScore(Q)=w₁·SemanticSim(Q)+w₂·T(Q,T)−w₃·U(Q),

where w₁, w₂, and w₃ are tunable weights.

In this manner, the disclosed multi-modal forecasting techniques incorporate time-based demand patterns, semantic similarity and/or uncertainty estimates into a single scoring function (e.g., thereby minimizing a risk of storing unneeded items).

FIG. 7 is a process diagram illustrating an exemplary implementation of a RL state formulation process 700 in accordance with an illustrative embodiment. In the example of FIG. 7, the RL state formulation process 700 employs an RL-driven, substantially continuous cache update strategy for new usage modes (e.g., post-launch surges and/or seasonal spikes).

At a time t, the RL state sₜ may be defined as follows:

sₜ=(Zₜ,CacheUsageₜ,HitRateₜ,ForecastScoresₜ),

where Zₜ indicates the current HGNN embeddings, CacheUsageₜ indicates the cache utilization statistics, HitRateₜ indicates the Current cache hit ratio and ForecastScoresₜ is a vector of forecast scores. The CacheUsageₜ and HitRateₜ values in the RL state vector sₜ may be directly derived in some embodiments from runtime cache telemetry. Specifically, CacheUsageₜ reflects the memory allocation and entry occupancy across tiers (e.g., RAM, SSD and distributed tiers), while HitRateₜ is computed by tracking successful cache retrievals over a rolling window. These cache metrics may be monitored and updated in real-time, forming part of the environment state that informs RL decision-making.

FIG. 8 is a process diagram illustrating an exemplary implementation of an RL-based cache action selection process 800 in accordance with an illustrative embodiment. In the example of FIG. 8, RL-based cache action selection process 800 defines the representative available actions as (i) CACHE(q) to store the query-response pair; (ii) EVICT(q) to remove a query-response pair from the cache; (iii) PROMOTE(q) to move a query-response pair to a higher tier of a multi-tier cache; (iv) DEMOTE(q) to move a query-response pair to a lower tier of a multi-tier cache; and (v) NO-OP to perform no operation. In some embodiments, performing a given action with respect to a given query-response pair may comprise performing the given action with respect to only the query portion or only the response portion of the given query-response pair (e.g., if the response portion of the given query-response pair is already stored in the cache). The representative available actions may be used to dynamically restructure a hypergraph. For example, frequently accessed nodes may form strong hyperedges and inactive nodes may gradually lose their links to conserve resources. In at least some embodiments, the action is selected by the RL agent 116 using the determined reward and state in accordance with one or more policies, as discussed further below in conjunction with FIG. 10. For a discussion of a suitable multi-tier cache, see, for example, U.S. patent application Ser. No. ______, entitled “Multi-Tier Caching of Language Model Queries,” (Attorney Docket No. 142424.01), filed contemporaneously herewith and incorporated by reference herein in its entirety.

A typical RL training cycle (e.g., every 10-30 minutes) may adjust caching actions based on recent performance.

FIG. 9 is a process diagram illustrating an exemplary implementation of a selected cache action execution process 900 in accordance with an illustrative embodiment. In the example of FIG. 9, for each query and corresponding selected action for the respective query (e.g., as identified in an incoming queries data structure), the selected cache action execution process 900 identifies the corresponding selected action. If the corresponding selected action is to cache the respective query, the selected cache action execution process 900 generates (e.g., by calling an LLM) or retrieves a cached response, if available, and adds the response to the query/response cache 118.

If the corresponding selected action is to promote the respective query, the selected cache action execution process 900 promotes the respective query to a higher tier of the query/response cache 118. If the corresponding selected action is to demote the respective query, the selected cache action execution process 900 demotes the respective query to a lower tier of the query/response cache 118. If the corresponding selected action is to evict the respective query, the selected cache action execution process 900 evicts the respective query from the query/response cache 118.

FIG. 10 is a process diagram illustrating an exemplary implementation of a reward computation and RL policy training process 1000 in accordance with an illustrative embodiment. In the example of FIG. 10, the reward computation and RL policy training process 1000 initially obtains cache statistics (e.g., cache hit rate, memory utilization and/or missed caching opportunities) from the query/response cache 118.

The reward computation and RL policy training process 1000 computes a reward, using a reward function, in the example of FIG. 10 that evaluates a change in the RL state, as discussed above in conjunction with FIG. 7 (e.g., the node embeddings, the obtained cache statistics and the forecast scores), between a time T and a subsequent time T+1. The reward function may be expressed, as follows:

R(s_{T},a_{T})=α·ΔHitRate−β·ΔMemUsage−γ·MissedOpportunities_{T},

where ΔHitRate is the change in the hit rate between time T and time T+1, ΔMemUsage is the change in the memory utilization between time T and time T+1, MissedOpportunities_{T} characterizes missed caching opportunities, α is a reward for a higher cache hit rate, β is a penalty for an excessive memory usage and γ is a penalty for missed caching opportunities. The MissedOpportunities_{T} term represents queries that, in hindsight, should have been cached but were not, resulting in one or more redundant LLM computations. The MissedOpportunities_{T} term may be derived from analyzing a window of repeated queries (e.g., in query logs and/or cache histories) where a previous cache miss was followed by a future cache hit for a semantically similar query (e.g., suggesting that caching the earlier query may have saved resources). Such queries may be flagged using the hypergraph structure and similarity scoring, effectively capturing regret. Thus, the MissedOpportunities_{T} term may be used to inform thew RL reward so that the RL agent 116 can learn from these mistakes and proactively adjust future cache policies.

The RL agent 116 may update or adapt the query/response cache 118 using proximal policy optimization (PPO) for scalable and stable updates and/or Q-Learning techniques if (i) the state/action spaces are discrete or (ii) when using a Deep Q network (DQN).

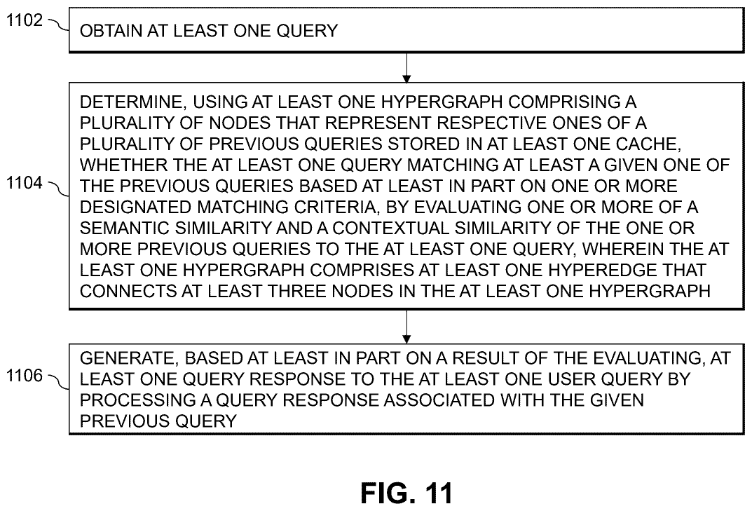

FIG. 11 is a flow diagram illustrating an exemplary implementation of a process for hypergraph-based caching of language model queries in accordance with an illustrative embodiment. In the example of FIG. 11, at least one query is obtained in step 1102.

In step 1104, at least one hypergraph comprising a plurality of nodes that represent respective ones of a plurality of previous queries stored in at least one cache is used to determine whether the at least one query matches at least a given one of the previous queries based at least in part on one or more designated matching criteria, by evaluating one or more of a semantic similarity and a contextual similarity of the one or more previous queries to the at least one query, wherein the at least one hypergraph comprises at least one hyperedge that connects at least three nodes in the at least one hypergraph. The term “cache,” as used herein, shall be broadly construed to encompass any processor-readable storage media including, without limitation, a storage array, a storage drive, including SSDs, or an integrated circuit comprising RAM, ROM or other electronic memory, or combinations thereof, in any configuration, including caches having multiple tiers and/or multiple levels, as well as distributed caches, or any of a wide variety of other types of storage products, as would be apparent to a person of ordinary skill in the art.

At least one query response to the at least one query is generated in step 1106, based at least in part on a result of the evaluating, by processing a query response associated with the given previous query.

In one or more embodiments, the process of FIG. 5 further comprises, in response to the at least one query not matching at least one of the previous queries based at least in part on the one or more designated matching criteria, (i) evaluating a complexity score of the at least one query relative to at least one designated complexity threshold, wherein the complexity score is based at least in part on one or more of a historical query usage, an estimated computation cost and a similarity of the at least one query to at least one of the one or more previous queries; and (ii) applying the at least one query to at least one language model to obtain a query response, in response to the at least one query satisfying one or more designated non-complex query criteria, without storing the at least one query and the query response in the at least one cache. In response to the at least one query satisfying one or more designated complex query criteria, the at least one query may be applied to at least one language model to obtain a query response; the at least one hypergraph may be updated to add at least one node to represent the at least one query; and a hyperedge in the at least one hypergraph may be connected between the at least one node and one or more related nodes, in the at least one hypergraph, that represent one or more previous queries, wherein the one or more related nodes are identified based at least in part on an evaluation of one or more of a semantic similarity and a contextual similarity of the one or more previous queries to the at least one query.

In some embodiments, the process of FIG. 5 further comprises performing at least one action with respect to the at least one cache, wherein the at least one action is selected, at least in part, by at least one processor-based reinforcement learning model that evaluates (i) a state comprising one or more of a representation of the at least one hypergraph, one or more cache utilization statistics, a cache hit rate ratio and a vector of forecast scores, and (ii) a reward based at least in part on one or more of the cache hit rate ratio, a memory utilization of the at least one cache and a designated missed cache opportunity metric, wherein the at least one action comprises one or more of caching a given query/query response pair, removing the given query/query response pair from the at least one cache, promoting the given query/query response pair to a higher cache tier and demoting the given query/query response pair to a lower cache tier. At least one forecasted query and a corresponding query response may be stored in the at least one cache based at least in part on an evaluation of the forecast score for the at least one forecasted query. The forecast score may comprise one or more of a semantic similarity component, a temporal pattern component and a query reuse uncertainty estimation component.

In at least one embodiment, one or more caching strategies of the at least one processor-based reinforcement learning model are updated based at least in part on one or more of real-time user feedback and a forecasted query demand. Real-time user feedback may include, for example, behavioral signals, such as thumbs-up/down on responses, response abandonment or time-to-click metrics after a query is served. These signals reflect implicit user satisfaction and can influence caching decisions (e.g., demoting low-value queries or reinforcing promotion of high-value queries) and may be used to adjust weights in the RL reward or as features in the state vector.

The at least one hypergraph may comprise a multi-layer hypergraph comprising at least a first layer comprising one or more nodes associated with one or more information categories and at least a second layer comprising a plurality of nodes associated with respective ones of a plurality of queries. The at least one query response may be represented as at least one node in the at least one hypergraph. At least portions of the at least one hypergraph may be updated using two or more geographically distributed computing devices. The at least one hypergraph may comprise a plurality of node embeddings for respective ones of a plurality of nodes, in the at least one hypergraph, wherein each node embedding represents one or more of a semantic similarity, a contextual overlap and a historical usage of the corresponding node with respect to other nodes in the hypergraph that represent past queries or responses, such that each embedding encodes contextual similarity, semantic overlap and/or a historical reuse likelihood.

The particular processing operations and other network functionality described in conjunction with FIGS. 3 through 11, for example, are presented by way of illustrative example only, and should not be construed as limiting the scope of the disclosure in any way. Alternative embodiments can use other types of processing operations for hypergraph-based caching of language model queries. For example, the ordering of the process steps may be varied in other embodiments, or certain steps may be performed concurrently with one another rather than serially. In one aspect, the process can skip one or more of the steps. In other aspects, one or more of the steps are performed simultaneously. In some aspects, additional steps can be performed.

Among other benefits, the disclosed hypergraph-based caching techniques provide (i) operational efficiency by reducing redundant token usage by efficiently caching responses based on query relationships; (ii) improved retrieval speed by using clustering and predictive caching techniques to improve retrieval times (e.g., by up to a factor of 200); (iii) real-time adaptability by dynamically updating the query/response cache 118 in response to query pattern changes; and (iv) scalability by employing hierarchical hypergraph modeling and/or edge computing to enable efficient operation even in complex, distributed environments.

In a financial institution handling millions of daily queries, for example, the disclosed hypergraph-based adaptive caching system reduces operational costs by caching responses for complex multi-dimensional queries, leading to faster query processing and improved system performance. It can be shown that the disclosed hypergraph-based caching techniques significantly improve (i) the cache hit rate (e.g., by 30-45% compared to LRU-based caching); (ii) latency for frequent queries (e.g., reduced from approximately 300 ms (for LLM calls) to under 10 milliseconds (for a cache retrieval); and (iii) token costs (e.g., by avoiding repetitive LLM calls for recurring queries, overall usage fees can drop significantly).

In addition, the disclosed hypergraph-based caching techniques can adapt to surges, which may be encountered, for example, in response to a new firmware update (e.g., which may trigger thousands of new queries). The hypergraph quickly connects these queries, and the RL agent 116 prioritizes them for caching, preventing a barrage of repeated LLM requests. While hypergraphs can be more complex than traditional data structures, efficient data partitioning (e.g., in an edge-based implementation) and specialized HGNN computations keep overhead manageable.

One or more embodiments of the disclosure provide improved methods, apparatus and computer program products for hypergraph-based caching of language model queries. The foregoing applications and associated embodiments should be considered as illustrative only, and numerous other embodiments can be configured using the techniques disclosed herein, in a wide variety of different applications.

It should also be understood that the disclosed techniques for hypergraph-based caching of language model queries, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for hypergraph-based caching of language model queries may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute and/or storage services can be offered to cloud infrastructure tenants or other system users as a Platform-as-a-Service (PaaS) model, an Infrastructure-as-a-Service (IaaS) model, a Storage-as-a-Service (STaaS) model and/or a Function-as-a-Service (FaaS) model, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based hypergraph-based caching engine, or portions thereof, are illustratively implemented for use by tenants of such a multi-tenant environment.

Cloud infrastructure as disclosed herein can include cloud-based systems. Virtual machines provided in such systems can be used to implement at least portions of a cloud-based hypergraph-based caching platform in illustrative embodiments. The cloud-based systems can include object stores.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

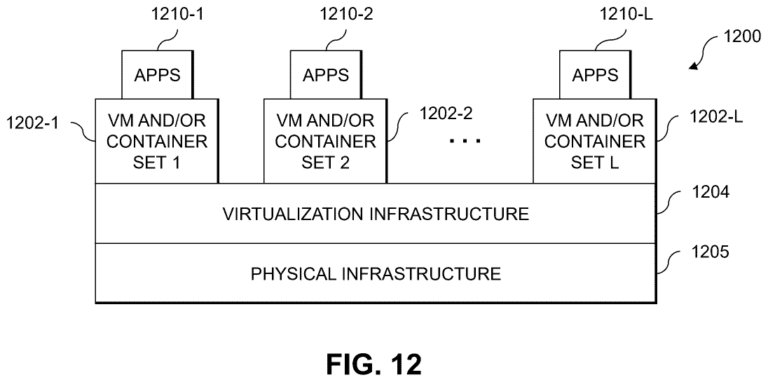

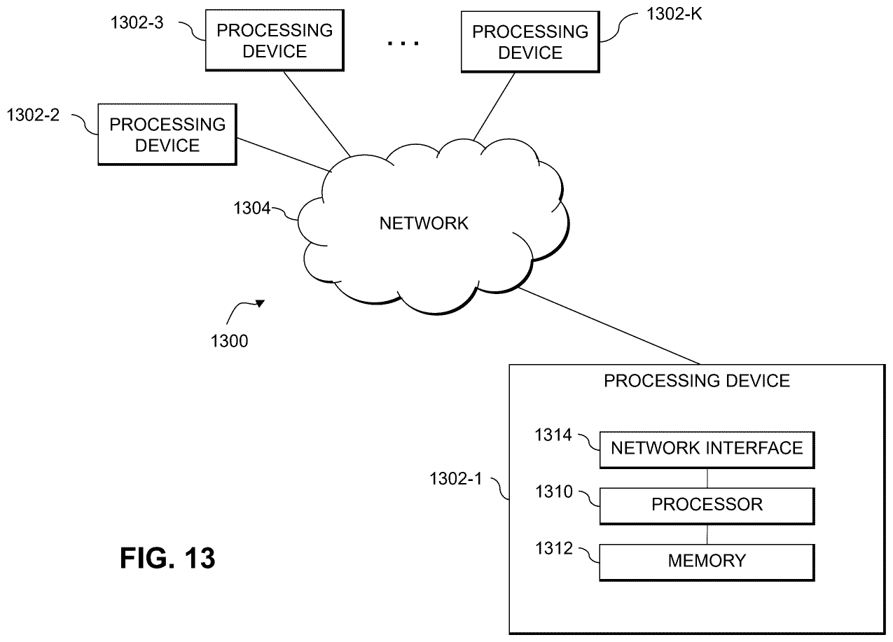

Illustrative embodiments of processing platforms will now be described in greater detail with reference to FIGS. 12 and 13. These platforms may also be used to implement at least portions of other information processing systems in other embodiments.

FIG. 12 shows an example processing platform comprising cloud infrastructure 1200. The cloud infrastructure 1200 comprises a combination of physical and virtual processing resources that may be utilized to implement at least a portion of the information processing system 100. The cloud infrastructure 1200 comprises multiple virtual machines (VMs) and/or container sets 1202-1, 1202-2, . . . 1202-L implemented using virtualization infrastructure 1204. The virtualization infrastructure 1204 runs on physical infrastructure 1205, and illustratively comprises one or more hypervisors and/or operating system level virtualization infrastructure. The operating system level virtualization infrastructure illustratively comprises kernel control groups of a Linux operating system or other type of operating system.

The cloud infrastructure 1200 further comprises sets of applications 1210-1, 1210-2, . . . 1210-L running on respective ones of the VMs/container sets 1202-1, 1202-2, . . . 1202-L under the control of the virtualization infrastructure 1204. The VMs/container sets 1202 may comprise respective VMs, respective sets of one or more containers, or respective sets of one or more containers running in VMs.

In some implementations of the FIG. 12 embodiment, the VMs/container sets 1202 comprise respective VMs implemented using virtualization infrastructure 1204 that comprises at least one hypervisor. Such implementations can provide hypergraph-based caching functionality of the type described above for one or more processes running on a given one of the VMs. For example, each of the VMs can implement control logic for hypergraph-based caching and associated functionality for generating query responses using at least one language model, when needed.

An example of a hypervisor platform that may be used to implement a hypervisor within the virtualization infrastructure 1204 is a compute virtualization platform which may have an associated virtual infrastructure management system such as server management software. The underlying physical machines may comprise one or more distributed processing platforms that include one or more storage systems.

In other implementations of the FIG. 12 embodiment, the VMs/container sets 1202 comprise respective containers implemented using virtualization infrastructure 1204 that provides operating system level virtualization functionality, such as support for Docker containers running on bare metal hosts, or Docker containers running on VMs. The containers are illustratively implemented using respective kernel control groups of the operating system. Such implementations can provide hypergraph-based caching functionality of the type described above for one or more processes running on different ones of the containers. For example, a container host device supporting multiple containers of one or more container sets can implement one or more instances of control logic for hypergraph-based caching and associated functionality for generating query responses using at least one language model, when needed.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1200 shown in FIG. 12 may represent at least a portion of one processing platform. Another example of such a processing platform is processing platform 1300 shown in FIG. 13.

The processing platform 1300 in this embodiment comprises at least a portion of the given system and includes a plurality of processing devices, denoted 1302-1, 1302-2, 1302-3, . . . 1302-K, which communicate with one another over a network 1304. The network 1304 may comprise any type of network, such as a WAN, a LAN, a satellite network, a telephone or cable network, a cellular network, a wireless network such as WiFi or WiMAX, or various portions or combinations of these and other types of networks.

The processing device 1302-1 in the processing platform 1300 comprises a processor 1310 coupled to a memory 1312. The processor 1310 may comprise a microprocessor, a microcontroller, an ASIC, an FPGA, a CPU, a GPU, a TPU, a VPU, an NPU, a DPU, an SOC or other type of processing circuitry, as well as portions or combinations of such circuitry elements, and the memory 1312, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage drive or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1302-1 is network interface circuitry 1314, which is used to interface the processing device with the network 1304 and other system components, and may comprise conventional transceivers.

The other processing devices 1302 of the processing platform 1300 are assumed to be configured in a manner similar to that shown for processing device 1302-1 in the figure.

Again, the particular processing platform 1300 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 12 or 13, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

1. A method, comprising:
obtaining at least one query;
determining, using at least one hypergraph comprising a plurality of nodes that represent respective ones of a plurality of previous queries stored in at least one cache, whether the at least one query matches at least a given one of the previous queries based at least in part on one or more designated matching criteria, by evaluating one or more of a semantic similarity and a contextual similarity of the one or more previous queries to the at least one query, wherein the at least one hypergraph comprises at least a given hyperedge that connects at least three nodes in the at least one hypergraph; and
generating, based at least in part on a result of the evaluating, at least one query response to the at least one query by processing a query response associated with the given previous query;
wherein the method is performed by at least one processing device comprising a processor coupled to a memory.

2. The method of claim 1, further comprising, in response to the at least one query not matching at least one of the previous queries based at least in part on the one or more designated matching criteria, (i) evaluating a complexity score of the at least one query relative to at least one designated complexity threshold, wherein the complexity score is based at least in part on one or more of a historical query usage, an estimated computation cost and a similarity of the at least one query to at least one of the one or more previous queries; and (ii) applying the at least one query to at least one language model to obtain a query response, in response to the at least one query satisfying one or more designated non-complex query criteria, without storing the at least one query and the query response in the at least one cache.

3. The method of claim 2, further comprising, in response to the at least one query satisfying one or more designated complex query criteria:
applying the at least one query to at least one language model to obtain a query response;
updating the at least one hypergraph to add at least one node to represent the at least one query; and
connecting a hyperedge in the at least one hypergraph between the at least one node to one or more related nodes, in the at least one hypergraph, that represent one or more previous queries, wherein the one or more related nodes are identified based at least in part on an evaluation of one or more of a semantic similarity and a contextual similarity of the one or more previous queries to the at least one query.

4. The method of claim 1, further comprising performing at least one action with respect to the at least one cache, wherein the at least one action is selected, at least in part, by at least one processor-based reinforcement learning model that evaluates (i) a state comprising one or more of a representation of the at least one hypergraph, one or more cache utilization statistics, a cache hit rate ratio and a plurality of forecast scores, and (ii) a reward based at least in part on one or more of the cache hit rate ratio, a memory utilization of the at least one cache and a designated missed cache opportunity metric, wherein the at least one action comprises one or more of caching a given query/query response pair, removing the given query/query response pair from the at least one cache, promoting the given query/query response pair to a higher cache tier and demoting the given query/query response pair to a lower cache tier.

5. The method of claim 4, further comprising storing at least one forecasted query and a corresponding query response in the at least one cache based at least in part on an evaluation of the forecast score for the at least one forecasted query.

6. The method of claim 4, wherein a given forecast score comprises one or more of a semantic similarity component, a temporal pattern component and a query reuse uncertainty estimation component.

7. The method of claim 4, wherein one or more caching strategies of the at least one processor-based reinforcement learning model are updated based at least in part on one or more of real-time user feedback, related to a user satisfaction, and a forecasted query demand.

8. The method of claim 1, wherein the at least one hypergraph comprises a multi-layer hypergraph comprising at least a first layer comprising one or more nodes associated with one or more information categories and at least a second layer comprising a plurality of nodes associated with respective ones of a plurality of queries.

9. The method of claim 1, wherein the at least one query response is represented as at least one node in the at least one hypergraph.

10. The method of claim 1, wherein at least portions of the at least one hypergraph are updated using two or more geographically distributed computing devices.

11. The method of claim 1, wherein the at least one hypergraph comprises a plurality of node embeddings for respective ones of a plurality of nodes, in the at least one hypergraph, wherein each node embedding represents one or more of a semantic similarity, a contextual overlap and a historical usage of the corresponding node with respect to one or more additional nodes in the at least one hypergraph representing one or more of a previous query and a previous response.

12. An apparatus comprising:
at least one processing device comprising a processor coupled to a memory;
the at least one processing device being configured to implement the following steps:
obtaining at least one query;
determining, using at least one hypergraph comprising a plurality of nodes that represent respective ones of a plurality of previous queries stored in at least one cache, whether the at least one query matches at least a given one of the previous queries based at least in part on one or more designated matching criteria, by evaluating one or more of a semantic similarity and a contextual similarity of the one or more previous queries to the at least one query, wherein the at least one hypergraph comprises at least one a given hyperedge that connects at least three nodes in the at least one hypergraph; and
generating, based at least in part on a result of the evaluating, at least one query response to the at least one query by processing a query response associated with the given previous query.

13. The apparatus of claim 12, further comprising performing at least one action with respect to the at least one cache, wherein the at least one action is selected, at least in part, by at least one processor-based reinforcement learning model that evaluates (i) a state comprising one or more of a representation of the at least one hypergraph, one or more cache utilization statistics, a cache hit rate ratio and a plurality of forecast scores, and (ii) a reward based at least in part on one or more of the cache hit rate ratio, a memory utilization of the at least one cache and a designated missed cache opportunity metric, wherein the at least one action comprises one or more of caching a given query/query response pair, removing the given query/query response pair from the at least one cache, promoting the given query/query response pair to a higher cache tier and demoting the given query/query response pair to a lower cache tier.

14. The apparatus of claim 12, further comprising storing one or more of at least one forecasted query and at least one corresponding query response in the at least one cache based at least in part on an evaluation of a forecast score for the at least one forecasted query.

15. The apparatus of claim 12, wherein one or more caching strategies of at least one processor-based reinforcement learning model are updated based at least in part on one or more of real-time user feedback, related to a user satisfaction, and a forecasted query demand.

16. The apparatus of claim 12, wherein the at least one hypergraph comprises a multi-layer hypergraph comprising at least a first layer comprising one or more nodes associated with one or more information categories and at least a second layer comprising a plurality of nodes associated with respective ones of a plurality of queries.

17. A non-transitory processor-readable storage medium having stored therein program code of one or more software programs, wherein the program code when executed by at least one processing device causes the at least one processing device to perform the following steps:
obtaining at least one query;
determining, using at least one hypergraph comprising a plurality of nodes that represent respective ones of a plurality of previous queries stored in at least one cache, whether the at least one query matches at least a given one of the previous queries based at least in part on one or more designated matching criteria, by evaluating one or more of a semantic similarity and a contextual similarity of the one or more previous queries to the at least one query, wherein the at least one hypergraph comprises at least one a given hyperedge that connects at least three nodes in the at least one hypergraph; and
generating, based at least in part on a result of the evaluating, at least one query response to the at least one query by processing a query response associated with the given previous query.

18. The non-transitory processor-readable storage medium of claim 17, further comprising performing at least one action with respect to the at least one cache, wherein the at least one action is selected, at least in part, by at least one processor-based reinforcement learning model that evaluates (i) a state comprising one or more of a representation of the at least one hypergraph, one or more cache utilization statistics, a cache hit rate ratio and a plurality of forecast scores, and (ii) a reward based at least in part on one or more of the cache hit rate ratio, a memory utilization of the at least one cache and a designated missed cache opportunity metric, wherein the at least one action comprises one or more of caching a given query/query response pair, removing the given query/query response pair from the at least one cache, promoting the given query/query response pair to a higher cache tier and demoting the given query/query response pair to a lower cache tier.

19. The non-transitory processor-readable storage medium of claim 17, further comprising storing one or more of at least one forecasted query and at least one corresponding query response in the at least one cache based at least in part on an evaluation of a forecast score for the at least one forecasted query.

20. The non-transitory processor-readable storage medium of claim 17, wherein one or more caching strategies of at least one processor-based reinforcement learning model are updated based at least in part on one or more of real-time user feedback, related to a user satisfaction, and a forecasted query demand.
